(19) United States
(12) Patent Application Publication
(10) Pub. No.: US 2025/0244763 A1
(43) Pub. Date: Jul. 31, 2025

(54) SYSTEM AND METHOD FOR PAYLOAD ATTITUDE AND POSITION ESTIMATION

(71) Applicant: Microavia International Limited, Dublin (IE)

(72) Inventors: Nikita Bondarev, Dubai (AE); Anton Babushkin, Zurich (CH); Yuriy Kamnev, Dubai (AE)

(21) Appl. No.: 18/427,035

(22) Filed: Jan. 30, 2024

(51) Int. Cl. G05D 1/248; G05D 1/672; G05D 109/20; G05D 111/50

(52) U.S. Cl. CPC G05D 1/248; G05D 1/672; G05D 2109/20; G05D 2111/50

(57) ABSTRACT

Systems and methods for estimating the position and attitude of a payload mounted on an unmanned vehicle (UV) and for correcting target data derived from the payload. Synchronized data is processed through an Extended Kalman Filter (EKF) to accurately estimate the payload's position and attitude. The payload position and attitude estimates are updated with new sensor data obtained during UV operation, and these estimates are used to correct raw target data from the payload.

### TECHNICAL FIELD

The invention relates generally to unmanned vehicle technologies and payload data processing systems. More particularly, the invention relates to systems and methods for accurately estimating the position and attitude of payloads attached to unmanned vehicles, and for correcting the data collected by these payloads, especially in dynamic and challenging operational environments.

### BACKGROUND

The present invention pertains to the field of unmanned vehicle technologies. Unmanned vehicles, such as drones and autonomous underwater vehicles, have become increasingly prevalent for various applications, including aerial photography, surveying, logistics, and environmental monitoring.

Traditional systems for estimating payload position and attitude often rely on sensors installed directly on the payload. These systems typically use a combination of Inertial Measurement Units (IMUs) and Global Navigation Satellite System (GNSS) receivers. However, integration of multiple sensors on a payload presents limitations, including increased complexity and cost due to duplicating all sensors on both the unmanned vehicle and the payload. Additionally, the extra weight of these sensors can impact the vehicle's performance and operational efficiency.

A significant challenge arises when operating in dynamic environments. Unmanned vehicles, especially aerial drones, are frequently subjected to external forces such as wind, motor vibrations, and abrupt maneuvers. These factors can cause substantial discrepancies between the actual and estimated positions and attitudes of the payloads. Traditional systems that use the vehicle's position as a proxy for the payload's position often fail to account for these discrepancies, leading to inaccuracies in payload monitoring.

In applications where payloads are sensitive to movement and require high precision, such as LIDAR systems or high-resolution cameras, the need for enhanced stability and accuracy becomes paramount. Existing solutions may not provide the necessary level of precision, especially in challenging operational conditions thereby hindering the effectiveness of unmanned vehicle applications that rely on precise payload positioning and orientation.

Therefore, there is a need for improved payload position and attitude estimation, and in particular, a comprehensive solution that optimally balances precision, cost, and operational flexibility for payloads requiring high accuracy in position and orientation data.

### SUMMARY

The present disclosure relates to a system and method for accurately estimating the position and attitude of payloads attached to unmanned vehicles, and for correcting the data collected by these payloads.

A method for estimating the position and attitude of a payload mounted to an unmanned vehicle (UV) with a mount comprises collecting positioning data from sensors on the UV, synchronizing the collected positioning data with an onboard processor of the payload as synchronized sensor data, uploading a dynamic model for a specific type of payload mounted to the UV, processing the synchronized sensor data and measurements received from a dedicated IMU of the payload and system parameters defined by the dynamic model using an Extended Kalman Filter (EKF) to estimate the position and attitude of the payload, outputting the position and attitude of the payload based on the processed data as a predicted payload position and attitude and correcting raw target data from the payload using the estimated position and attitude to produce precise data.

In one aspect, the collected positioning data includes data from a Global Navigation Satellite System (GNSS) receiver.

In one aspect, the collected positioning data includes data from an Inertial Measurement Unit (IMU).

In one aspect, the dynamic model is configured to mechanical constraints of the mount, including degrees of freedom and damping properties.

In one aspect, synchronizing the collected positioning data includes aligning timestamps of the sensors on the UV with timestamps of the onboard processor of the payload.

In one aspect, the payload is a camera or LIDAR.

In one aspect, the method further comprises continuously updating the predicted payload position and attitude with new sensor data obtained during the operation of the UV.

A system for estimating the position and attitude of a payload mounted to an unmanned vehicle (UV) comprises an unmanned vehicle (UV), a payload communicatively coupled to the UV, a mount connecting the payload to the UV, configured to allow specific degrees of freedom and having damping properties and the dynamic model uploaded to the system corresponding to the type of the payload, defining the system parameters. The UV comprises a sensor configured to collect positioning data. A payload comprises a processor configured to obtain positioning data from the UV in a synchronized manner as synchronized positioning data, a dedicated Inertial Measurement Unit (IMU) configured to capture motion-related data, and an Extended Kalman Filter (EKF) module configured to process the synchronized positioning data, motion-related data and system parameters defined by a dynamic model to estimate the position and attitude of the payload.

In one aspect, the system further comprises an autopilot of the UV configured to process the collected sensor data and to determine the position of the UV.

In one aspect, the processor is further configured to obtain the determined UV position as positioning data.

In one aspect, the autopilot system of the UV is further configured to receive feedback from the EKF to adjust flight control for optimized target data acquisition.

In one aspect, the synchronized positioning data includes an alignment of timestamps.

In one aspect, the system further comprises a target data sensor configured to collect raw target data.

In one aspect, the system further comprises a data corrector configured to correct raw target data using the estimated position and attitude of the payload to produce precise data.

In one aspect, the sensor is a Global Navigation Satellite System (GNSS) receiver.

In one aspect, the sensor is an Inertial Measurement Unit (IMU).

In one aspect, the sensor is a compass.

In one aspect, the dynamic model is adapted to the specific mechanical constraints of the mount, including degrees of freedom and damping properties.

A method for estimating position and attitude of a payload on an unmanned vehicle (UV) that is operably coupled to the payload with a mount comprises collecting UV sensor data, synchronizing the sensor data with motion-related data from the payload using a timestamp as synchronized sensor data, estimating the position and attitude of the payload using an Extended Kalman Filter (EKF) based on the synchronized sensor data as a predicted payload and attitude, correcting raw target data from the payload using the predicted payload and attitude.

The above summary is not intended to describe each illustrated embodiment or every implementation of the subject matter hereof. The figures and the detailed description that follow more particularly exemplify various embodiments.

### BRIEF DESCRIPTION OF THE DRAWINGS

Subject matter hereof may be more completely understood in consideration of the following detailed description of various embodiments in connection with the accompanying figures, in which:

FIG. 1 is a schema of an equipped unmanned aerial vehicle, according to an embodiment.

FIG. 2 is a block diagram depicting the relative movement of an unmanned vehicle and a payload under different operational states, according to an embodiment.

FIG. 3A is a raw surface map captured using a LIDAR system mounted on damped mounts.

FIG. 3B is a precise surface map corrected based on an estimated payload's position, according to an embodiment.

FIG. 4 is a block diagram of an equipped unmanned vehicle, according to an embodiment.

FIG. 5 is a functional schema of payload exact position estimation and target data correction, according to an embodiment.

FIG. 6 is a flowchart of a method for payload exact position estimation and target data correction, according to an embodiment.

While various embodiments are amenable to various modifications and alternative forms, specifics thereof have been shown by way of example in the drawings and will be described in detail. It should be understood, however, that the intention is not to limit the claimed inventions to the particular embodiments described. On the contrary, the intention is to cover all modifications, equivalents, and alternatives falling within the spirit and scope of the subject matter as defined by the claims.

### DETAILED DESCRIPTION

Unmanned vehicles (UVs) encompass a broad range of vehicles operated without direct human control. These vehicles can be classified based on their operational environment, such as aerial unmanned aerial vehicles (UAVs), terrestrial unmanned ground vehicles (UGVs), aquatic unmanned surface vehicles (USVs), and subaquatic unmanned underwater vehicles (UUVs). Each category of UVs can be further divided by its application, size, range, and the nature of its control systems, whether autonomous or remotely-piloted.

Mounts for payloads on UVs are components that directly affect the stability and efficacy of the data collection process. Mounts are typically categorized by their stabilization capabilities and range of motion. Damped mounts utilize materials and mechanisms that absorb vibrations and shocks. Motorized mounts incorporate servo motors or stepper motors that offer precise control over the payload's orientation. Articulated mounts feature joints and linkages that provide multiple degrees of freedom, and telescopic mounts can extend or retract, changing the payload's relative position to the UV.

Payloads for UVs are diverse, including sensors and instruments designed for specific operational tasks. Cameras, as an example of a payload, capture visual data in the form of images or videos. A LIDAR payload generates surface maps by emitting laser pulses and measuring the reflected signals to calculate distances. Other payloads can include thermal cameras, multispectral sensors, scientific instruments, or even cargo for delivery purposes.

Target payload data refers to the specific data gathered by the payload's key sensor. For a camera, target data can be high-resolution images or continuous video footage, which can be used in surveillance, inspection, or environmental monitoring. In the case of a LIDAR sensor, the target payload data can be detailed surface maps and 3D models of the environment, which are vital for applications such as topographic mapping, archaeology, and urban planning.

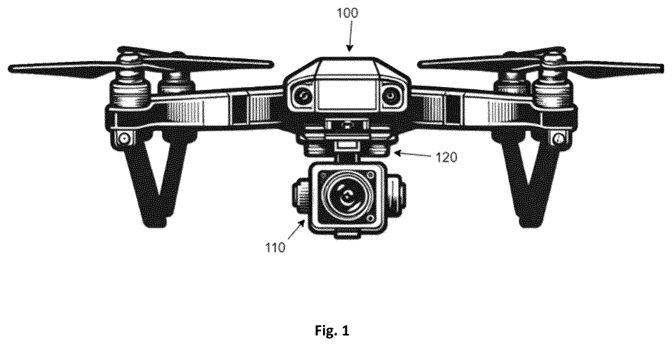

Referring to FIG. 1, a schema of an equipped unmanned aerial vehicle is depicted, in an embodiment. In one embodiment, an unmanned aerial vehicle 100 is equipped with a payload, specifically a camera 110, which is installed on the unmanned aerial vehicle 100 using a damped mount 120. The unmanned aerial vehicle 100 includes a plurality of rotors and an onboard navigation system, not shown in FIG. 1, for stabilizing and navigating the unmanned aerial vehicle 100 through three-dimensional space.

The camera 110 is operably coupled to the unmanned aerial vehicle 100 and is configured to capture images and videos. In another embodiment, the camera 110 may include additional sensors not shown in FIG. 1, such as an Inertial Measurement Unit (IMU) for capturing motion data. The unmanned aerial vehicle 100, equipped with a damped mount 120, is configured to decrease the vibration of a camera and relative motion of the payload, such as the camera 110 or a LIDAR system, from the standpoint of the unmanned aerial vehicle 100. Despite damped vibrations, there remains a challenge that any residual movement of the payload relative to the unmanned aerial vehicle 100 can still occur due to various external and operational factors. These residual movements must be corrected to ensure the accuracy of the target data.

In the case of a payload configured as a LIDAR system, precise distance measurements and attitude data are utilized. The ability of the LIDAR to accurately map the environment or perform detailed surveys is contingent upon the stability of the LIDAR relative to the ground and the target objects. Any uncorrected motion imparted by the unmanned aerial vehicle 100, even damped by the damped mount 120, can lead to inaccuracies in the LIDAR data, potentially resulting in flawed representations of the surveyed area.

Similarly, for a payload configured as a camera 110, maintaining an in-focus image requires stability, particularly when capturing high-resolution or long-exposure photography. Movements between the camera 110 and the unmanned aerial vehicle 100, if not adequately corrected, can cause motion blur or misalignment of the captured imagery, diminishing the quality of the photographic data.

In one embodiment, the damped mount 120 not only mechanically connects the camera 110 to the unmanned aerial vehicle 100 but also facilitates the transfer of data and control signals. The damped mount 120 is equipped with the necessary interfaces to allow for the bi-directional transfer of data packets between the camera 110 and the unmanned aerial vehicle 100. The connectivity channel ensures that the camera 110 can receive control commands from the onboard systems of the unmanned aerial vehicle 100. The connectivity channel ensures that the camera 110 can transmit captured image and video data back to the unmanned aerial vehicle 100 for processing or relay to the ground control station 120.

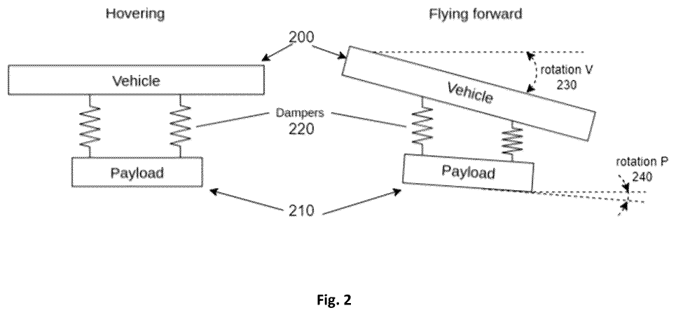

Referring to FIG. 2, a block diagram depicting the relative movement of an unmanned vehicle 200 and a payload 210 under different operational states is depicted, according to an embodiment. FIG. 2 illustrates two distinct states: “Hovering” and “Flying forward.”

In the “Hovering” state, the unmanned vehicle 200 is stationary in the air, and the payload 210 is depicted as being stationary relative to the unmanned vehicle 200. The payload 210 is connected to the unmanned vehicle 200 via dampers 220, which serve to cushion any vibrational forces that may act upon the payload 210.

As the unmanned vehicle 200 transitions to the “Flying forward” state, dynamics change considerably. The unmanned vehicle 200 tilts forward at a rotation angle V 230 as the unmanned vehicle 200 moves with acceleration, which is a typical maneuver for maintaining forward momentum. Concurrently, the payload 210, while still connected to the unmanned vehicle 200 via dampers 220, oscillates in one plane relative to the unmanned vehicle 200, turning through a rotation angle P 240 relative to the horizon. FIG. 2 illustrates the payload's degree of freedom to move.

The angle of relative rotation between the unmanned vehicle 200 and the payload 210 in an ideal system is determined by the design of the mount, which includes considerations of materials used, tolerances of distances between structural parts, and the overall geometry of the design. Additionally, the mass and geometry of the payload 210 itself play significant roles in the vibration characteristics of the payload 210.

The dynamic model within the context of unmanned vehicle systems, such as the unmanned vehicle 200 illustrated in FIG. 2, is utilized for predicting and managing the behavior of a payload 210 in relation to its mount and the vehicle itself. The dynamic model captures the dynamic interaction between the unmanned vehicle 200 and the payload 210, considering the degrees of freedom facilitated by various types of mounts. The dynamic model defines mechanical constraints of the mount. In other embodiments, other relational characteristics are considered, such as coupling between the mount and vehicle.

For damped mounts, such as the dampers 220 shown in FIG. 2, the dynamic model focuses on the constrained roll and pitch movements permitted by the damping mechanism. The model includes parameters defining the mechanical properties of the dampers 220, which dictate how the payload 210 responds to inertial forces and movements of the unmanned vehicle 200.

In motorized mounts, the dynamic model encompasses a broader range of controlled movements. Motorized mounts enable precise adjustments across multiple axes, allowing dynamic repositioning of the payload 210. The model for such mounts details the actuator capabilities, control algorithms, and the response of the payload 210 to actuator-induced movements.

Articulated mounts introduce multi-axis movement capabilities, which necessitate a dynamic model that accounts for joint angles, linkage configurations, and the sequences of movements the payload 210 can undertake. These mounts are particularly useful for tasks that require the payload 210 to maneuver through complex spatial paths.

Telescopic mounts are modeled to highlight their capacity for altering the position of the payload 210 along a single axis, offering an additional degree of freedom for payloads that benefit from variable positioning. The dynamic model for telescopic mounts includes parameters such as extension range, retraction mechanics, and the speed of these movements.

For systems that combine different mount types, the dynamic model integrates the individual characteristics of each mount into a cohesive system. The integrated dynamic model can adapt to a wide array of operational requirements, providing both stability and precise positioning for the payload 210.

System parameterization further defines the spatial relationship between reference points of the unmanned vehicle 200 and the origin of the payload 210. The spatial relationship includes the dual offsets—one from the center of unmanned vehicle 200 to the mount point and another from the mount point to the center of payload 210. By employing the dual-offset approach, the dynamic model effectively separates parameters of the unmanned vehicle 200 parameters from those of the payload 210, enhancing the system's adaptability.

Additionally, the dynamic model takes into account the characteristics of the dampers 220, where applicable. Damping characteristics encompasses the range of motion the dampers 220 allow and their damping coefficients, which influence the reaction of the payload 210 to the movements of the unmanned vehicle 200 and any external disturbances.

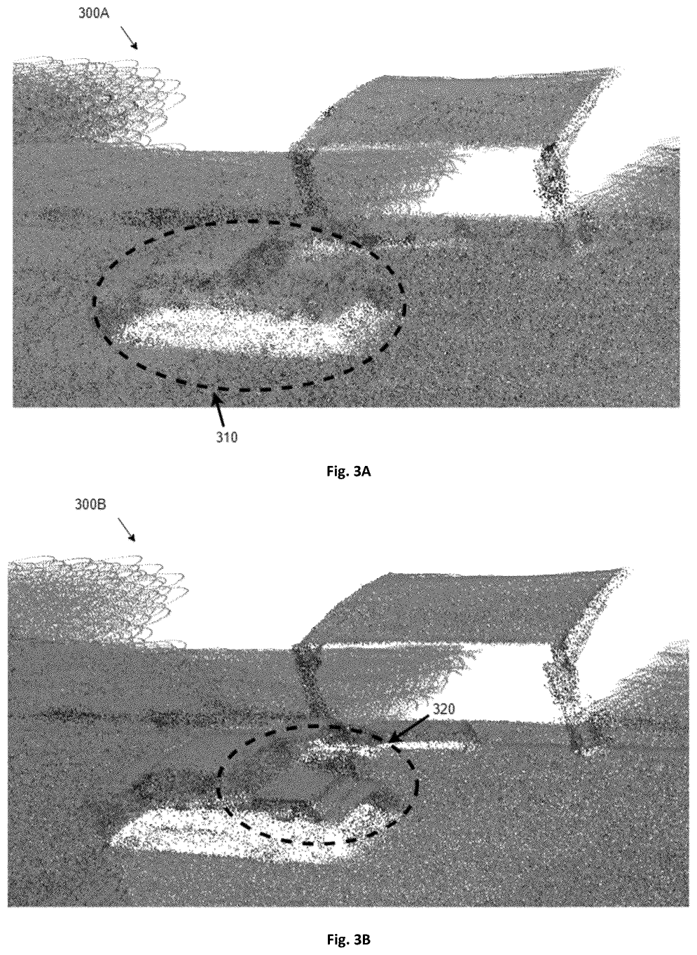

Referring to FIG. 3A, a raw surface map captured using a LIDAR system mounted on damped mounts is illustrated. The map reveals a street scene with various objects, where the objects are visualized with a level of dispersion indicative of vibration-induced errors in the LIDAR data. Notably, a larger object such as a car 310 is detectable amidst the noise.

In contrast, FIG. 3B depicts an enhanced raw surface map produced using an advanced payload positioning system and method, according to an embodiment. The improvement in the quality of the data is evident, with significantly reduced dispersion of detectable objects. The enhanced map allows for the identification of finer details, exemplified by a smaller object like a box 320 situated on the car.

The comparison between FIGS. 3A and 3B demonstrates the effectiveness of the enhanced payload positioning system. In FIG. 3A, the presence of vibrations from the LIDAR results in a surface map suitable primarily for detecting larger objects. In FIG. 3B, the system's capability to produce more detailed and accurate data, enabling the detection of small-scale features is illustrated. This example underscores the importance of the method where target data is refined through improved payload position and attitude estimation techniques, details of which are discussed further herein.

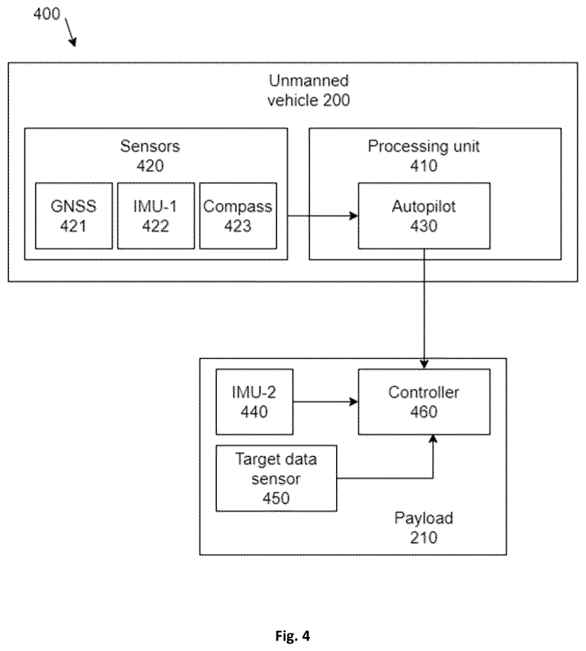

Referring to FIG. 4, a block diagram of an equipped unmanned vehicle 200 with a system for accurate payload positioning is depicted, according to an embodiment. Unmanned vehicle 200 is designed to forgo additional positioning sensors within its payload 210, instead leveraging data from the sensors of the unmanned vehicle 200 and autopilot 430.

The unmanned vehicle 200 is equipped with an array of sensors 420 integral to its navigation and positioning capabilities. These sensors include a Global Navigation Satellite System (GNSS) receiver 421, an Inertial Measurement Unit (IMU-1) 422, and a compass 423, among potentially other positioning sensors not explicitly shown in the diagram. The sensors 420 provide real-time data on the spatial orientation, velocity, and geographic location of the unmanned vehicle 200.

A processing unit 410 within the unmanned vehicle 200 interprets the data from the sensors 420 to maintain and adjust the flight dynamics of the unmanned vehicle 200. In an embodiment, the processing unit 410 can be operably coupled to memory. The autopilot 430 utilizes such data to ascertain the position and attitude of the unmanned vehicle 200 and to generate control signals that guide the unmanned vehicle 200 in accordance with its mission parameters and to compensate for external factors, such as weather conditions.

The payload 210, which can be a camera system, LIDAR sensor, or another instrument dependent on precise positioning, includes its dedicated Inertial Measurement Unit (IMU-2) 440 and a controller 460. The IMU-2 440 captures motion-related data specific to the payload 210, such as vibrations or independent movements, which are not directly related to the maneuvers of the unmanned vehicle 200. In an embodiment, the controller 460 can be operably coupled to memory.

The payload 210 does not contain its own GNSS receiver or compass; instead, the payload 210 relies on the position data provided by the autopilot 430 of the unmanned vehicle 200. The controller 460 receives the calculated position of the unmanned vehicle 200 from the autopilot 430 and determines the exact position of the payload 210 using a dynamic model that accounts for the mechanical linkage between the payload 210 and the unmanned vehicle 200. The dynamic model enables the controller 460 to correct for any relative movement between the unmanned vehicle 200 and the payload 210, ensuring target data accuracy of the payload 210.

Optionally, the payload 210 can incorporate a target data sensor, which directly utilizes the refined position and orientation data to enhance the quality and precision of its output, such as high-definition images or detailed surface maps. The integration of a refined position in the target sensor of payload 210 underscores a system where the sophisticated sensor suite of the unmanned vehicle 200 is leveraged to augment the functionality of the payload 210 without necessitating redundant positioning systems within the payload itself.

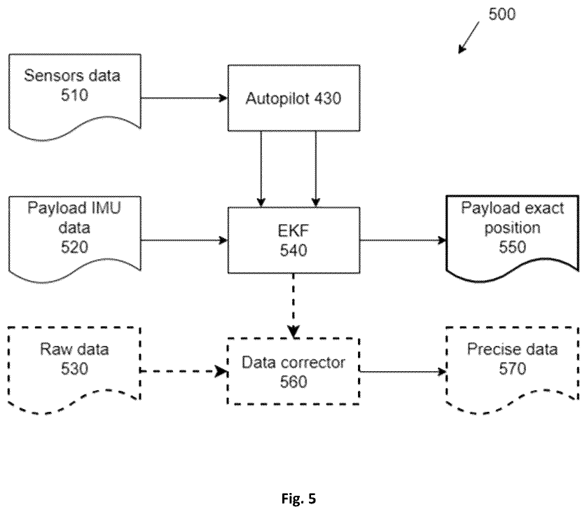

Referring to FIG. 5, a functional schema of payload precise position estimation and target data correction is depicted, according to an embodiment. FIG. 5 depicts a data flow that begins with sensor data 510 from an unmanned vehicle's array of navigational instruments, which is then processed by the autopilot 430. The autopilot 430, along with the payload's onboard processor, is time-synchronized to ensure that the collected data is accurately timestamped, facilitating precise data matching and integration. Time synchronization, essential for ensuring that the data streams from the vehicle and the payload are precisely aligned in time, is utilized for the accurate fusion and processing of data by the Extended Kalman Filter (EKF). The timestamp alignment ensures that the positional and attitudinal estimations made by the EKF are based on data that is temporally coherent, eliminating discrepancies that could arise from data misalignment. The accurate synchronization of these data streams is vital for the precision of the EKF's output, which directly influences the quality of the corrected target data, leading to more reliable and accurate results in applications such as terrain mapping or object detection.

Payload IMU data 520, sourced from the payload's own Inertial Measurement Unit (IMU), is also fed into the EKF 540. The EKF 540 uses these inputs to make initial predictions about the payload's position and attitude, taking into account the vehicle's state and any known parameters of the system, such as those pertaining to mount characteristics and payload configuration.

Subsequent to the initial prediction, the EKF 540 engages in sequential updating, refining the payload's position estimation with each new cycle of sensor data 510 and payload IMU data 520. Such an iterative process incorporates the latest readings and corrects for any discrepancies due to relative motion between the payload and the unmanned vehicle. Discrepancy calculations are particularly important in instances where the payload is mounted on motorized or damped mounts, as these mounts can introduce specific rotations and movements that need to be accounted for to ensure accurate position and attitude estimations.

In the case of motorized mounts, the EKF 540 integrates the orientation of the unmanned vehicle with encoder data from the motors to pinpoint the angular position of the payload. EKF 540 calculates payload attitude using payload's IMU, then corrects the calculated payload attitude with the drone angular position, calculated by the drone's autopilot (with EKF in the autopilot), adjusted by the relative rotation, calculated from encoders. For damped mounts, the EKF 540 calculates the relative rotation between the unmanned vehicle and the payload's angular position as estimated by the payload's IMU, adjusting for any movement that is not aligned with the vehicle's course.

The output of the EKF 540, the exact position 550 of the payload, serves as an input for the data corrector 560, which applies the necessary adjustments to the raw data 530 to produce precise data 570. These corrections are based on the refined estimations of the payload's position and attitude, ensuring that the payload's measurements are as accurate as possible. In an embodiment, precise data 570 can be replaced in data streams where raw data 530 would typically have been used.

Enhanced accuracy is vital in applications requiring detailed surveying or mapping, where both the software and hardware may need to make real-time adjustments to the payload's operation based on the EKF data. The corrected spatial information from the EKF 540 can be used by the unmanned vehicle for onboard processing or by the payload itself for payload-level processing. Furthermore, post-processing can refine the payload's data using the synchronized and corrected position and orientation information, which is essential for generating high-quality end products, such as detailed maps or complex image analysis.

In different embodiments of the system depicted in FIG. 5, components such as the EKF 540 and the autopilot 430 can be either hardware-based or software-based, offering flexibility depending on the application. In such embodiments, certain components of the system can be implemented on hardware remote from the UV. The UV can be operably coupled to such remote components through a network or other communication interface. Hardware implementation can increase the system's overall cost and complexity. On the other hand, a software-based implementation, running on a general-purpose computing platform within the unmanned vehicle or payload, provides versatility and ease of updates or customization. A flexibility of software-based implementation is advantageous for applications such as environmental monitoring or agricultural mapping, where adaptability to varying conditions is key.

Moreover, in embodiments, certain functionalities can be transferred between system components. For example, it may be advantageous for UV components to implement certain functionality when the output is time-critical or when the UV is unable to communicate with remote components. In another example, it may be advantageous for remote components to implement certain functionality when UV battery life is critical.

The Extended Kalman Filter (EKF) algorithm is central to the process of estimating the exact position and attitude of a payload. The EKF operates in a series of computational operations to refine the state estimates of the payload's position and attitude through a combination of prediction and measurement updates.

The algorithm begins with Initialization, where the state vector (x) is established. The state vector encapsulates the initial estimates of the payload's position and attitude. Accompanying the state vector is the covariance matrix (P), which quantifies the initial uncertainty associated with these state estimates.

Proceeding to the Predict Step, the state prediction formula x{pred}=f(x{prev}, u) is applied, where f( ) represents the state transition function, x{prev} is the state vector from the previous step, and u denotes the control input derived from the unmanned vehicle's sensors. The covariance matrix is also predicted, using the formula P{pred}=F*P{prev}*F\hat{ }T+Q, where F is the Jacobian matrix of the state transition function, P{prev} is the covariance matrix from the previous step, and Q symbolizes the process noise covariance.

In the subsequent Update Step, the measurement update occurs, utilizing the formula y=z−h(x{pred}), with z representing the actual measurements, h being the measurement function, and x{pred} the predicted state vector. The Jacobian of the measurement function (H) is calculated to inform the computation of the Kalman Gain (K) using the formula K=P{pred} H\hat{ }T(HP{pred}H\hat{ }T+R)\hat{ }{−1}, where R is the measurement noise covariance. The state vector is then updated to x{updated}=x{pred}+Ky, and the covariance matrix is revised to P{updated}=(I−KH)*P{pred}. The estimation process is repeated with each new iteration, using the updated state and covariance estimates as the starting point for the next cycle, ensuring that the payload's position and attitude are continually refined.

The EKF is instrumental in enhancing the precision of the payload's position and attitude estimates, which are integral components of the state vector x. Through the prediction and update cycles, the EKF systematically reduces the uncertainty in these estimates, as indicated by the decreasing values within the covariance matrix P. The dispersion, or the measure of uncertainty, diminishes with each iteration, signaling an increase in the confidence level of the state estimates, which is utilized for the accuracy of the payload's operational data.

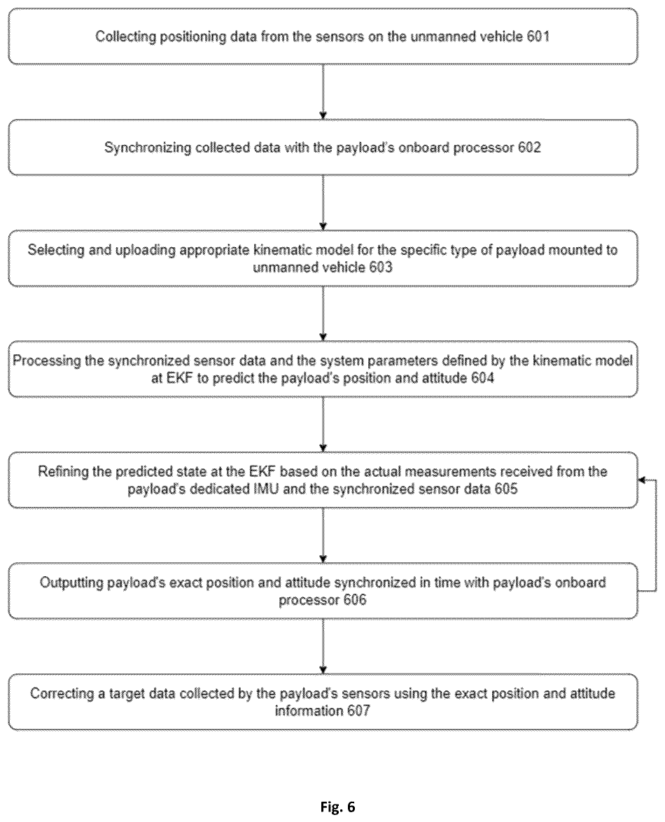

Referring to FIG. 6, a flowchart of a method for estimating the exact position and attitude of a payload on an unmanned vehicle and for subsequent correction of the payload's target data is depicted, according to an embodiment.

At 601, positioning data is collected from the sensors on the unmanned vehicle, which can include a Global Navigation Satellite System (GNSS) receiver, an Inertial Measurement Unit (IMU), a compass, and other navigation aids. The collected data forms the basis for all subsequent position and attitude estimations. In an embodiment, data collection can include continuous or periodic collection from sensors.

At 602, the collected data is synchronized with the payload's onboard processor. The synchronization operation at 602 ensures that the time-stamped data from the unmanned vehicle aligns with the data from the payload, allowing for accurate data fusion and processing.

At 603, an appropriate dynamic model is selected and loaded based on the specific type of payload and mount in use. In an embodiment, the dynamic model can be associated with both the payload and mount. In other embodiments, the dynamic model can be associated with other suitable characteristics that reflect the hardware implemented by the UV and mount (such as fasteners, etc.) The dynamic model accounts for the physical and operational characteristics of the mount mechanism, such as its damping properties and degrees of freedom, and tunes the Extended Kalman Filter (EKF) system parameters for the calculation process. In an embodiment, the dynamic model can be automatically selected. In other embodiments, the dynamic model can be conditionally automatically selected but approved by a user.

In an embodiment, a dynamic model defines the following parameters: a) degrees of freedom of the mount; b) Spatial Offsets (Including offsets in three-dimensional space (x, y, z) and might also account for angular offsets); c) Damping Characteristics. Optionally, the dynamic model can define other parameters that can be used for advanced mount types of high-precise data gathering: d) motion dynamics (velocities and accelerations of payload and vehicle in different axes are used for understanding how the vehicle's movements impact the payload); e) control inputs from the vehicle's autopilot (like thrust, tilt angles, etc.), which directly influences the vehicle's motion and, indirectly, the payload's position; f) payload characteristics (mass, dimensions, tensors of inertia and center of gravity).

At 604, the Extended Kalman Filter (EKF) uses the synchronized sensor data and the system parameters defined by the dynamic model to process and predict the payload's position and attitude. In an embodiment, 604 involves a state prediction, followed by a covariance prediction that considers the process noise.

In an embodiment, the state transition function of the EKF (used in the prediction operation) is informed by the dynamic model. The EKF uses the model to predict the future state (position and orientation) of the payload based on current state and control inputs.

In yet another embodiment, measurement function(s) in the EKF, which maps the predicted state to the expected measurement, is also based on the dynamic model. Measurement functions of the EKF helps to correlate the payload's predicted position and orientation with the actual sensor readings.

At 605, the EKF performs an update using the actual measurements received from the payload's dedicated IMU. 605 refines the predicted state based on the latest data, adjusting the state vector and the covariance matrix to reduce the level of uncertainty in the estimates. In embodiments, the predicted state can be updated continuously or intermittently.

At 606, the EKF's refined estimates of the payload's exact position and attitude are outputted. These estimates are utilized for accurate payload operation, especially for sensitive payloads such as LIDAR systems or high-resolution cameras that require precise spatial information.

At 607, the raw target data collected by the payload's sensors is corrected using the exact position and attitude information. The correction at 607 ensures that the data is free from errors that could be introduced by the payload's movements or vibrations, resulting in precise and reliable payload data.

1. A method for estimating the position and attitude of a payload mounted to an unmanned vehicle (UV) with a mount, comprising:
collecting positioning data from sensors on the UV;
synchronizing the collected positioning data with an onboard processor of the payload as synchronized sensor data;
uploading a dynamic model for a specific type of payload mounted to the UV;
processing the synchronized sensor data and measurements received from a dedicated IMU of the payload and system parameters defined by the dynamic model using an Extended Kalman Filter (EKF) to estimate the position and attitude of the payload;
outputting the position and attitude of the payload based on the processed data as a predicted payload position and attitude; and
correcting raw target data from the payload using the estimated position and attitude to produce precise data.

2. The method of claim 1, wherein the collected positioning data includes data from a Global Navigation Satellite System (GNSS) receiver.

3. The method of claim 1, wherein the collected positioning data includes data from an Inertial Measurement Unit (IMU).

4. The method of claim 1, wherein the dynamic model is configured to mechanical constraints of the mount, including degrees of freedom and damping properties.

5. The method of claim 1, wherein the synchronizing the collected positioning data includes aligning timestamps of the sensors on the UV with timestamps of the onboard processor of the payload.

6. The method of claim 1, wherein the payload is at least one of a camera or LIDAR.

7. The method of claim 1, further comprising:
continuously updating the predicted payload position and attitude with new sensor data obtained during the operation of the UV.

8. A system for estimating the position and attitude of a payload mounted to an unmanned vehicle (UV), the system comprising:
an unmanned vehicle (UV), comprising:
a sensor configured to collect positioning data;
a payload communicatively coupled to the UV, comprising:
a processor configured to obtain positioning data from the UV in a synchronized manner as synchronized positioning data,
a dedicated Inertial Measurement Unit (IMU) configured to capture motion-related data, and
an Extended Kalman Filter (EKF) module configured to process the synchronized positioning data, motion-related data and system parameters defined by a dynamic model to estimate the position and attitude of the payload;
a mount connecting the payload to the UV, configured to allow specific degrees of freedom and having damping properties; and
the dynamic model uploaded to the system corresponding to the type of the payload, defining the system parameters.

9. The system of claim 8, further comprising an autopilot of the UV configured to process the collected sensor data and to determine the position of the UV.

10. The system of claim 9, wherein the processor is further configured to obtain the determined UV position as positioning data.

11. The system of claim 9, wherein the autopilot system of the UV is further configured to receive feedback from the EKF to adjust flight control for optimized target data acquisition.

12. The system of claim 8, wherein the synchronized positioning data includes an alignment of timestamps.

13. The system of claim 8, further comprising a target data sensor configured to collect raw target data.

14. The system of claim 13, further comprising a data corrector configured to correct raw target data using the estimated position and attitude of the payload to produce precise data.

15. The system of claim 8, wherein the sensor is Global Navigation Satellite System (GNSS) receiver.

16. The system of claim 8, wherein the sensor is Inertial Measurement Unit (IMU).

17. The system of claim 8, wherein the sensor is a compass.

18. The system of claim 8, wherein the dynamic model is adapted to the specific mechanical constraints of the mount, including degrees of freedom and damping properties.

19. The system of claim 8, wherein the payload is at least one of a camera or LIDAR.

20. A method for estimating position and attitude of a payload on an unmanned vehicle (UV), the UV operably coupled to the payload with a mount, the method comprising:
collecting UV sensor data;
synchronizing the sensor data with motion-related data from the payload using a timestamp as synchronized sensor data;
estimating the position and attitude of the payload using an Extended Kalman Filter (EKF) based on the synchronized sensor data as a predicted payload and attitude;
correcting raw target data from the payload using the predicted payload and attitude.
